(19) United States
(12) Patent Application Publication
(10) Pub. No.: US 2018/0113919 A1
(43) Pub. Date: Apr. 26, 2018

(54) Graphical user interface rendering predicted query results to unstructured queries

(71) Applicant: GOOGLE LLC, Mountain View, CA (US)

(72) Inventors: Ritendra Datta, Union City, CA (US); Amr Ahmed, Mountain View, CA (US); Chao-Yuan Wu, Austin, TX (US); Gowtham Ramani Kumar, Mountain View, CA (US)

(21) Appl. No.: 15/792,173

(22) Filed: Oct. 24, 2017

Related U.S. Application Data
(60) Provisional application No. 62/412,253, filed on Oct. 24, 2016.

(51) Int. Cl. G06F 17/30; G06N 3/02; G06Q 30/06

(52) U.S. Cl. CPC G06F 17/30554; G06F 17/30398; G06Q 30/0625; G06N 3/02; G06F 17/30867

(57) ABSTRACT

Rendering graphical user interfaces display query results based on latent intent of users comprises a query network system. The query server stores data for each result of a group of search results, the product data comprising one or more items of metadata that are usable by the one or more computing devices and are not presented with the results for display to a user computing device. The server correlates items of metadata associated with results selected after first query to determine latent intent of the user. The server receives a second query and determines that the second query includes terms related to the first query. The server determines a latent intent of the second query based on the correlation and provides instructions to the user computing device to render a graphical user interface, the graphical user interface comprising the query results.

### RELATED APPLICATIONS

This application claims priority under 35 U.S.C. § 119 to U.S. Patent Application No. 62/412,253 filed Oct. 24, 2016, and entitled “Deep Learning for Shopping Query Understanding.” The entire contents of the above-identified application is hereby fully incorporated herein by reference.

### TECHNICAL FIELD

The present disclosure relates to a graphical user interface that renders query results on a user computing device. More specifically, a graphical user interface renders results that are identified based on predicted latent structured intent of unstructured queries.

### BACKGROUND

In online queries, users typically express intent for a desired result through search queries. However, these queries are often ambiguous, and the desired result is not clearly identified. For example, it is more likely (and easier) for users to write a query such as “high-end bike” than “21 speed carbon frame Brand X road bike.” A query system struggles to interpret ambiguous queries, and thus search result accuracy suffers. A user frequently must go through a burdensome process of refining search queries or iteratively entering new search terms until the preferred results are obtained.

Further, user queries typically are highly unstructured. The intent can be ambiguous. For example, the meaning of “birthday gift for daughter,” “camping equipment,” or “affordable mattress” depends on context and differs from user to user. For example, one user may desire a birthday gift for an infant, while another may desire a gift for a teenager. In addition, a query usually does not form a complete sentence, but just a list of key words in arbitrary order. Queries also often contain typographical errors, and can be expressed in user-dependent ways. Modeling these unstructured and noisy queries in a robust and accurate way is challenging for conventional systems.

The processing of a conventional query proceeds in a structured approach that is composed of category hierarchy, brands, product lines, features, etc. If a query network could understand a user's intent as if the user had provided a structured, organized query, the query network could identify results with more responsive categories, brands, or features and display those results to the user. Conventional systems cannot infer the latent intents of the user to improve query results. Thus, when a user provides an unstructured query, the results presented to the user on the graphical user interface often are not relevant to the result for which the user was searching. Results are presented that may be associated with one or more keywords of the query, but are not related to the actual intent of the user in the query.

### SUMMARY

Techniques herein provide computer-implemented methods to render graphical user interfaces of predicted query results of unstructured queries. The methods include receiving, by one or more computing devices, result data for each item of a group of results, the result data comprising first metadata that is usable by the one or more computing devices and are not displayed with primary search results in a rendered graphical user interface. The computing devices receive a first query comprising a data query, the first query being input into a graphical user interface hosted by the one or more computing devices, and identify one or more selections of results for the first query that are displayed on the graphical user interface. The computing devices associate the first metadata associated with the selected results with the first query and determine that the first metadata is representative of latent intent of the first query. The computing devices receive a second query comprising a second data query, the second query being input into the graphical user interface hosted by the one or more computing devices and determine that the second query includes one or more terms related to the first query. The computing device determines a latent intent of the second query based on the associating of the first query and the metadata associated with the selected results, and based on the determination that the second query includes one or more terms related to the first query and provides instructions to the user computing device causing the user computing device to render a graphical user interface comprising second query results, based on the determined latent intent of the second query.

In certain other example aspects described herein, systems and computer program products to render graphical user interfaces render graphical user interfaces to display query results based on latent intent of users are provided.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to display a graphical user interface of a query result based on inferred user intent, in accordance with certain examples.

FIG. 2 is an illustration of an example graphical user interface displaying a query and query results, in accordance with certain examples.

FIG. 3 is a block flow diagram depicting a method to render a graphical user interface of a query result based on inferred user intent, in accordance with certain examples.

FIG. 4 is a block flow diagram depicting a method to learn the attributes of query terms and store those attributes, in accordance with certain examples.

FIG. 5 is a block diagram depicting a computing machine and a module, in accordance with certain examples.

### DETAILED DESCRIPTION

### Overview

In certain examples, a query network system renders graphical user interfaces to display query results based on latent intent of users. With each new query, the query network system learns the latent attributes that are associated with query terms in shopping queries and displays products on a graphical user interface. A query network system employing a machine learning processor, such as a bidirectional recurrent neural network (“BRNN”), receives inputs of product data and the metadata associated with the products from merchants or other sellers. The metadata may be any associated tags or other data transmitted by a merchant system with the product data. In an example, a product offering for a Spiderman costume might include metadata such as “superhero,” “boy,” “under 10,” “Halloween,” “mask,” and “costume.”

The query system stores the product data that are actually selected by users based on shopping queries and learns the latent intent of the users when submitting the query. For example, a user enters a query for “Spiderman costume,” and then selects the product offering with example tags of “superhero,” “boy,” “under 10,” “Halloween,” “mask,” and “costume.” The query system may deduce that the user is searching for a product that is associated with one or more of these tags of metadata.

The latent intent of the user in the current query is based on the implied attributes determined from the stored metadata. Based on the query terms entered by the user, the machine learning system is able predict the results for which the user actually intended to search, despite the unstructured or vague query terms. The latent intent may be a list of query terms that would return the result for which the user was actually searching. A structured query of the latent intent of the user is determined to be what the user would have searched if the user had entered a properly structured search based on the results that the user actually desired with sufficient appropriate query terms to make the user's intent perfectly clear. The structured query includes the query terms determined to be associated with the latent intent of the user. Users seldom optimize query terms to provide the query network system with a clear intent of the user. Thus, the need exists to determine a structured search query that represents the latent intent behind the query terms that are actually submitted.

The next time a user enters a search query including the terms “Spiderman costume,” the query system is able to predict that the user is likely interested in one or more of the metadata terms, such as “boy,” “under 10,” and “superhero.” The query system will display to the user, not just the product selected previously by a user, but other products that are associated with those metadata terms. For example, a Superman costume that also has the metadata of “boy,” “under 10,” and “superhero.” The products presented to the user in the graphical user interface are thus based on the latent intent of the user and not merely on associated keywords searches or other limited data.

In one embodiment a computer-implemented method renders graphical user interfaces to display query results derived from latent query intent, comprising: receiving, using one or more computing devices, result data for each item of a group of results, the result data comprising first metadata that is usable by the one or more computing devices and are not displayed with primary search results in a rendered graphical user interface on a user computing device; receiving, using the one or more computing devices and from the user computing device, a first query comprising a data query, the first query being input into a graphical user interface hosted by the one or more computing devices; identifying, using the one or more computing devices, one or more selections of results for the first query via an input on the graphical user interface on the user computing device; associating, using the one or more computing devices, the first metadata associated with the selected results with the first query; determining, using the one or more computing devices, that the first metadata is representative of latent intent of the first query; receiving, using the one or more computing devices and from a second user computing device, a second query comprising a second data query, the second query being input into the graphical user interface hosted by the one or more computing devices; determining, using the one or more computing devices, that the second query includes one or more terms related to the first query; determining, using the one or more computing devices, a latent intent of the second query based on the associating of the first query and the metadata associated with the selected results, and based on the determination that the second query includes one or more terms related to the first query; and providing, using the one or more computing devices, instructions to the user computing device causing the user computing device to render a graphical user interface comprising second query results, based on the determined latent intent of the second query.

In one embodiment the method further comprise presenting, by the graphical user interface on the user computing device, the query results. In a further embodiment metadata is received as product tags associated with a product description. In one embodiment the determination that the second query includes one or more terms related to the first query is based on a comparison of each of the terms of the second query to each of the terms in the first query to search for matches, wherein a greater number of matches indicates that second query and the first query are more related.

In addition or alternatively an embodiment of the computer-implemented method comprises one or more computing devices with a machine learning computing system as a part of the query network system configured to receive inputs of product data and the metadata associated with the products, the metadata in particular being associated tags or other data transmitted by a system with the product data, the query system storing the product data that are actually selected by users based on queries, in particular shopping queries to learn the latent intent of the users when submitting the query.

In one embodiment the computer-implemented method comprises one or more computing devices employing a neural network to perform the correlation. The neural network can e.g. be a bidirectional recurrent neural network. In one embodiment the one or more computing devices employs a machine learning algorithm to perform the correlation.

In a further embodiment, the determined latent intent of the first query comprises a set of structured search query terms that were intended in the search query based on the metadata associated with the selected results.

In one embodiment, the one or more selections of results include receiving a selection of a link presented in the results displayed via the graphical user interface on the user computing device.

One embodiment of the method comprises determining that the second query includes one or more terms related to the first query is based on a comparison of the first query terms to the second query terms.

In one embodiment of the method the determined latent intent of the second query comprises a set of structured search query terms that were intended in the search query.

In one embodiment of the method the latent intent of the second query comprises a set of structured search query terms that were intended in the search query based on the determined latent intent of the first query.

In one embodiment of the method the attributes of the latent intent of users is categorized into one or more categories. In particular the one or more categories can e.g. include one or more of a brand name, a product feature, and an age group of a likely purchaser.

A further embodiment is a computer program product, comprising: a non-transitory computer-readable storage device having computer-executable program instructions embodied thereon that when executed by a computer cause the computer to render graphical user interfaces to display query results based on intended structured queries, the computer-executable program instructions comprising: computer-executable program instructions to store product data for each product of a group of products, the product data comprising one or more items of metadata that are usable by the one or more computing devices and are not available for display to a user computing device; computer-executable program instructions to receive a first query comprising a product data query, the first query being input into a graphical user interface hosted by the one or more computing devices; computer-executable program instructions to associate, with the first query, the items of metadata associated with products that are selected from the results of the first query to determine latent intent of a user when submitting the first query; computer-executable program instructions to receive a second query comprising a second product data query, the second query being input into the graphical user interface hosted by the one or more computing devices; computer-executable program instructions to determine that the second query includes one or more terms related to the first query; computer-executable program instructions to determine a latent intent of the second query based on the associating of the first query and the items of metadata associated with the selected products, and based on the determination that the second query includes one or more terms related to the first query; and computer-executable program instructions to provide, based on the determined latent intent of the second query, instructions to the user computing device causing the user computing device to render a graphical user interface comprising the query results.

In an embodiment of the computer program product the items of metadata are received as product tags associated with a product description. One embodiment can employ a bidirectional recurrent neural network to perform the correlation. A further embodiment can employ a machine learning algorithm to perform the correlation. In another embodiment the one or more selections of products include clicking a link presented in the results displayed on the graphical user interface.

In a further embodiment the computer program product comprises, computer-executable program instructions for a machine learning computing system as a part of the query network system configured to receive inputs of product data and the metadata associated with the products, the metadata, in particular being associated tags or other data transmitted by a system with the product data, the query system comprising computer-executable program instructions for storing the product data that are actually selected by users based on queries, in particular shopping queries to learn the latent intent of the users when submitting the query.

Yet another embodiment is a system to render graphical user interfaces to display query results derived from latent query intent, the graphical user interfaces generated in response to search queries, comprising: a storage resource; and a processor communicatively coupled to the storage resource, wherein the processor executes application code instructions that are stored in the storage resource to cause the system to:

store product data for each product of a group of products, the product data comprising one or more items of metadata that are usable by the one or more computing devices and are not available for display to a user computing device; receive a first query comprising a product data query, the first query being input into a graphical user interface hosted by the one or more computing devices; associate with the first query the items of metadata associated with products that are selected from the results of the first query to determine latent intent of a user when submitting the first query; receive a second query comprising a second product data query, the second query being input into the graphical user interface hosted by the one or more computing devices; determine that the second query includes one or more terms related to the first query; determine a latent intent of the second query based on the associating of the first query and the items of metadata associated with the selected products, and based on the determination that the second query includes one or more terms related to the first query; and provide, based on the determined latent intent of the second query, instructions to the user computing device causing the user computing device to render a graphical user interface comprising the query results.

In an embodiment of the system the one or more computing devices comprise a machine learning computing system as a part of the query network system configured to receive inputs of product data and the metadata associated with the products, the metadata in particular being associated tags or other data transmitted by a system with the product data, the query system storing the product data that are actually selected by users based on queries, in particular shopping queries to learn the latent intent of the users when submitting the query.

By using and relying on the methods and systems described herein, an online shopping site is able to better to understand a user's intent through these structured attributes. The reasons are at least twofold. First, this allows the system to present information in a way that aligns with how users understand, reason, and make decisions, and thus ease the shopping process. For instance, given a search query “cheap sofa,” telling the users what brands, features, or textures are cheaper is more important than just finding sofas that have “cheap” in their product data. As such, the systems and methods described herein may be employed to providing this structured information and greatly ease the process of research and decision making for the user. Secondly, if the system can identify relevant item attributes for a given query, the system can find more relevant results and thus reduce user's frustration by minimizing the number of times the user needs to refine the search queries.

### Example System Architectures

Turning now to the drawings, in which like numerals represent like (but not necessarily identical) elements throughout the figures, example embodiments are described in detail.

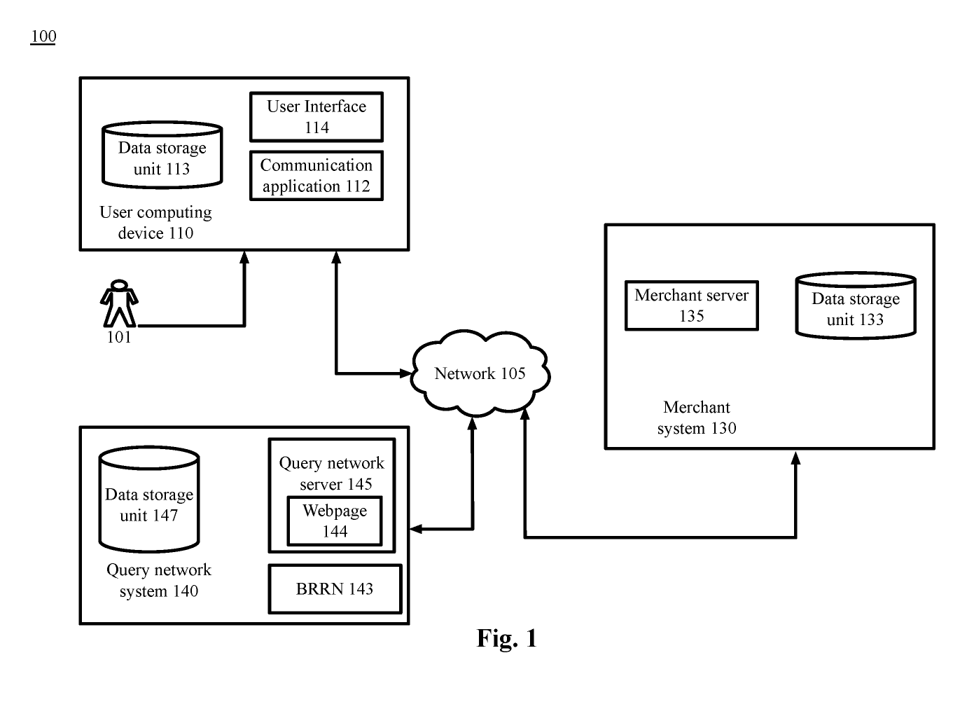

FIG. 1 is a block diagram depicting a system 100 to display a graphical user interface 114 of a query result based on inferred user intents. In some embodiments, a user 101 associated with a user computing device 110 must install an application and/or make a feature selection to obtain the benefits of the techniques described herein.

As depicted in FIG. 1, the system 100 includes network computing devices/systems 110, 130, and 140 that are configured to communicate with one another via one or more networks 105 or via any suitable communication technology.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

Each network computing device/system 110, 130, and 140 includes a computing device having a communication module capable of transmitting and receiving data over the network 105 or a similar network. For example, each network device 110, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 1, the network devices 110, 130, and 140 are operated by end-users or consumers, merchant system operators, and query network system operators, respectively.

The user computing device 110 includes a user interface 114. The user interface 114 may be used to display a graphical user interface and other information to the user 101 to allow the user 101 to interact with the query network system 140 and others. The user interface 114 receives user input for queries and displays results to the user 101. In certain examples, the user interface 114 may be provided with a graphical user interface by the query network system 140. The user interface 114 may be accessed by the processor of the user computing device 110. The user interface 114 may display the webpage 144 of the query network system 140. The user interface 114 may be provided input, configuration data, and other display directions by the webpage 144 of the query network system 140 to the user computing device 110. In certain examples, the user interface 114 may be managed by a merchant system 130 or others. In certain examples, the user interface 114 may be managed by the user computing device 110 and be prepared and displayed to the user 101 based on the operations of the user computing device 110.

The user 101 can use the communication application 112 on a user computing device 110, which may be, for example, a web browser application or a stand-alone application, to view, download, upload, or otherwise access documents or webpages through the user interface 114 via a distributed network 105. The communication application 112 can interact with web servers or other computing devices connected to the network 105, including the web server 145 of the query network system 140. In an example, the communication application 112 is a web browser that accesses and displays the webpage 144 of the query network system 140 via the user interface 114. The communication application 112 allows the user to enter search functions for a product or other search and receive results, product displays, products for sale, advertisements, offers, or other suitable webpage displays through the graphical user interface 114. The communication application 112 may alternatively be an application that connects to the query network system 140 or other systems to search products for sale.

The user computing device 110 also includes a data storage unit 113 accessible by the communication application 112 and one or more applications, such as the digital wallet application (not shown). The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

An example of the one or more merchant systems, such as merchant system 130 comprises merchant system server 135 and a data storage unit 133.

In an example embodiment, the merchant system server 135 communicates with the query network system 140 or other systems to transmit and receive product data. The merchant server 135 may represent the computing system of merchants, manufacturers, distributors, pricing programs, or other suitable parties (not shown). The merchant system server 135 provides product data to the query network system 140 or other requestors.

In an example embodiment, the data storage unit 133 can include any local or remote data storage structure accessible to the merchant system 130 suitable for storing information. In an example embodiment, the data storage unit 133 stores encrypted information.

An example query network system 140 comprises a query network system server 145, a webpage 144, a data storage unit 143, and a machine learning computing system, such as a bidirectional recurrent neural network (“BRNN”) 143.

In an example embodiment, the query network system server 145 communicates with the merchant system 130 or other systems over network 105 to request and receive product data that are available for purchase. The query network server 145 may receive data from the merchant systems 130, manufacturers, distributors, pricing programs, and other suitable parties. The query network system server 145 provides a webpage 144. The webpage 144 may be utilized by user 101 or others to request data for products for sale, input user information, receive product data, or perform any other suitable actions. The webpage 144 may be managed or provided by the query network system server 145 or any other suitable server. The webpage 144 may alternatively represent an interface on an application or other software for interacting with the user 101 or the user computing device 110.

In an example embodiment, the data storage unit 147 can include any local or remote data storage structure accessible to the query network system 140 suitable for storing information. In an example embodiment, the data storage unit 147 stores encrypted information.

The bidirectional recurrent neural network (“BRRN”) 143 represents any type of neural network computing system or other computing system that employs any machine learning process or algorithm. The BRRN 143 is able to receive data from many varied sources and use the data to interpret the latent intent of the user 101 based on a search query. The BRRN 143 is able to continually or periodically update the received information in a manner that allows the data presented by the query network system 140 to become more useful as more data is received and stored. The BRRN 143 may be a function or computing device of the query network system 140 that is used by the query network system 140 to perform some or all of the correlations, matches, predictions, determinations of intent, determinations of implied attributes, or other functions herein that are described as being performed by the query network system 140 or the query network server 145.

It will be appreciated that the network connections shown are examples and other means of establishing a communications link between the computers and devices can be used. Moreover, those having ordinary skill in the art having the benefit of the present disclosure will appreciate that the merchant system 130, query network system 140, and the user computing device 110 illustrated in FIG. 1 can have any of several other suitable computer system configurations. For example, a user computing device 110 can be embodied as a mobile phone or handheld computer, and may not include all the components described above.

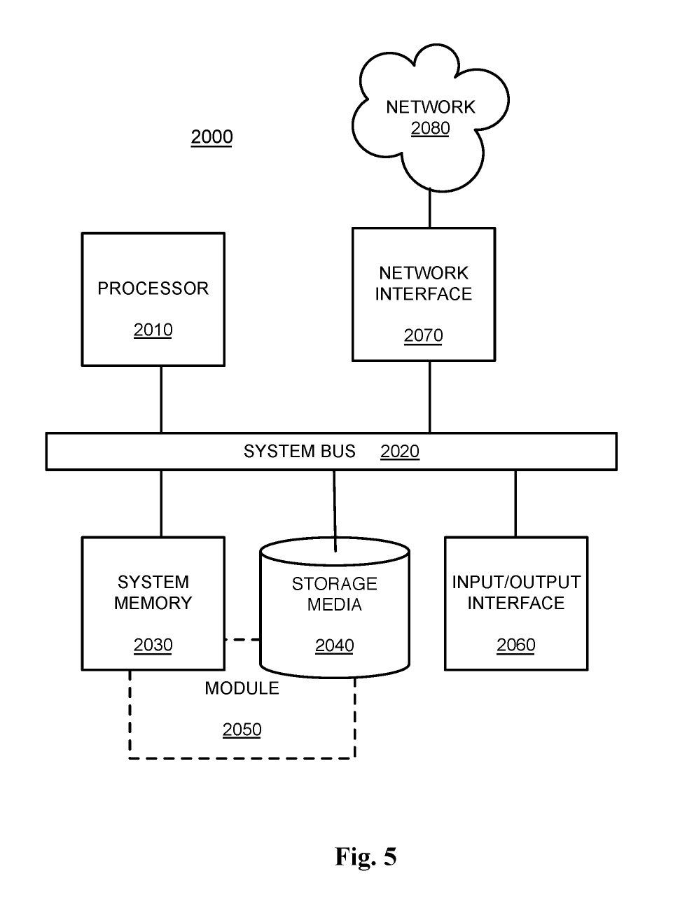

In example embodiments, the network computing devices and any other computing machines associated with the technology presented herein may be any type of computing machine such as, but not limited to, those discussed in more detail with respect to FIG. 5. Furthermore, any functions, applications, or components associated with any of these computing machines, such as those described herein or any others (for example, scripts, web content, software, firmware, hardware, or modules) associated with the technology presented herein, may by any of the components discussed in more detail with respect to FIG. 5. The computing machines discussed herein may communicate with one another, as well as with other computing machines or communication systems over one or more networks, such as network 105. The network 105 may include any type of data or communications network, including any of the network technology discussed with respect to FIG. 5.

### Example Processes

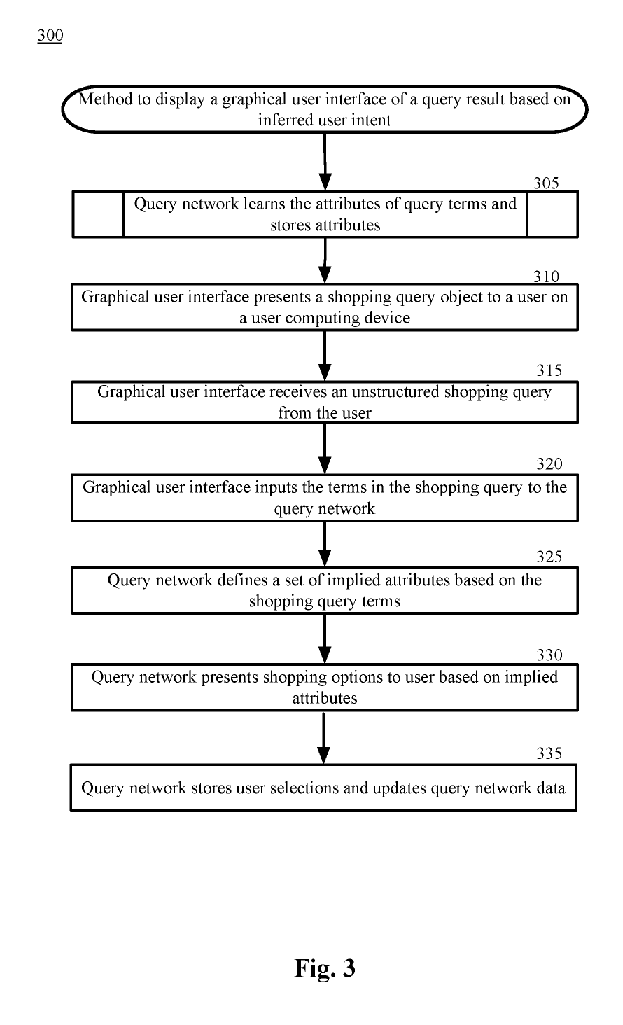

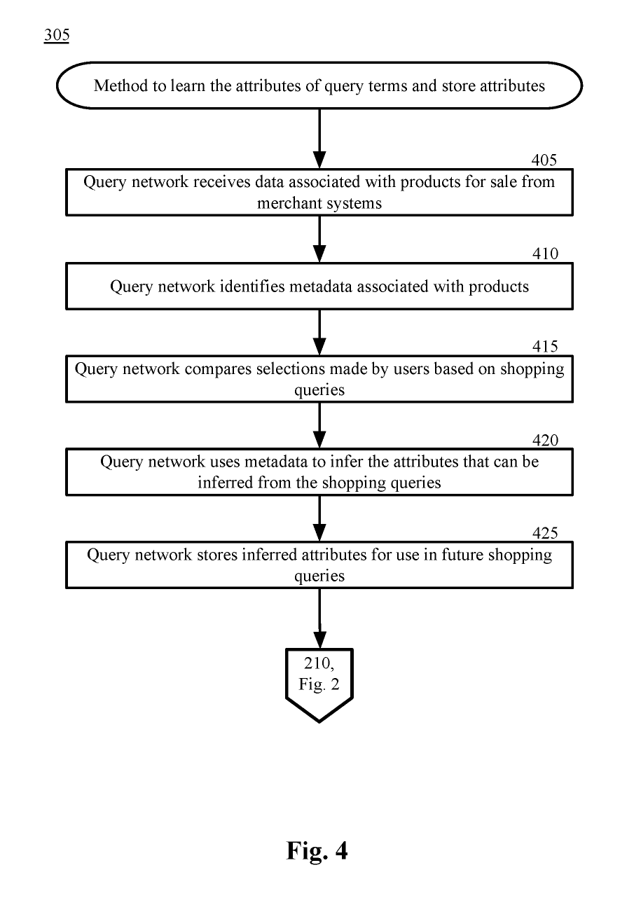

The example methods illustrated in FIG. 3-4 are described hereinafter with respect to the components of the example operating environment 100. The example methods of FIG. 3-4 may also be performed with other systems and in other environments. The operations described with respect to any of the FIGS. 3-4 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 3 is a block flow diagram depicting a method 300 to display a graphical user interface of a query result based on inferred user intents, in accordance with certain example embodiments.

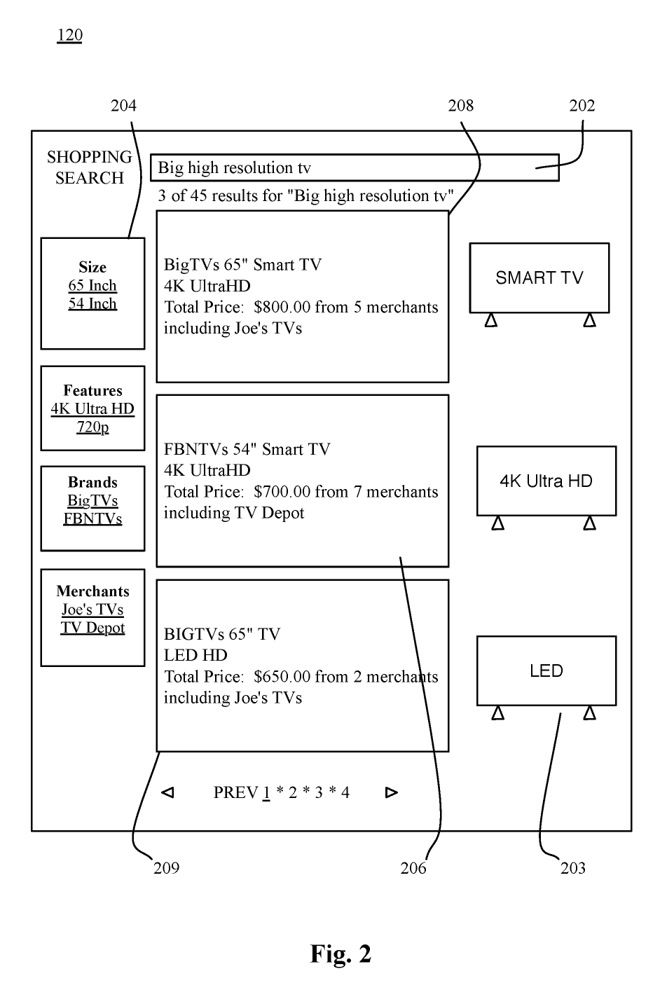

With reference to FIGS. 2 and 3, in block 305, a query network system 140 learns the attributes intended with query terms and stores the attributes. The details of block 305 are described in greater detail with respect to method 305 of FIG. 4.

FIG. 4 is a block flow diagram depicting a method 225 to learn the attributes intended with query terms and store attributes, in accordance with certain example embodiments.

In block 405, the query network system 140 receives data associated with products for sale from merchant systems 130. The query network system 140 may request a list of the products that each merchant system 130 has available for sale and store the products and the associated data in the web server 145. The query network system 140 may crawl merchant websites or other shopping sites to gather product data and pricing data. The query network system 140 may obtain the product data via any other data collection technique. The query network system 140 may obtain the product data at the time of a request by a user 101 or at a time previous to the request.

The product data may be communicated to the query network system 140 via an Internet message over the network 105, email, instant message, text, or any other suitable communication technology. The query network system 140 stores the product data received from the merchant system 130 in the query network system server 145 or in any other suitable location. The product data may be stored in a database or other suitable format for easy search and access by the query network system 140. The database may be sorted by any available criteria, such as by product name, product code, product serial number, price, keyword data, product metadata, or any other suitable data.

In block 410, the query network system 140 identifies metadata associated with the received product data. The metadata may be any data that is associated with the product, such as tags, descriptions, or keywords associated with a product listing. As described previously, the metadata associated with a Spiderman costume might include “superhero,” “boy,” “under 10,” “Halloween,” “mask,” “Brand X Model 4321,” and “costume.” The metadata might be attached to the product listing, but hidden from view of users 101. For example, the query network system 140 enters user query results from previous and current search queries into a machine learning algorithm. The query network system 140 also enters the particular results selected by the user that entered the query. The query network system 140 also enters the metadata associated with the search results into the machine learning algorithm.

In block 415, the query network system 140 compares selections made by users 101 based on shopping queries. The query network system 140 may perform the comparison on previous shopping queries that have been stored along with the selections made based on the previous shopping queries. When one or more users 101 enter a query, the query network system 140 extracts the keywords from shopping queries or analyzes the query as a whole. The query network system 140 identifies the products that the user 101 selects after making the query. The query network system 140 then identifies the metadata associated with those selected products. The products may be selected if the user 101 purchases the products, if the user 101 merely clicks on the product to obtain more information, or if the user 101 performs any other action indicating an interest in a product.

When a product is identified as being selected by the user 101, the query network system 140 identifies metadata associated with that product. The metadata may be aggregated with other products that are selected by the user 101 or other users. For example, if ten different users typed the query “Spiderman costume,” then the query network system 140 would collect the metadata for all of the products selected by those ten users.

Alternatively, the query network system 140 compares the metadata for each word in the query. That is, instead of the ten users that specifically queried “Spiderman costume,” the query network system 140 compares the metadata associated with the selections of users that entered queries that included the words “Spiderman” or “costume.” The queries may or may not have had one or more other query terms included in the query. The query network system 140 identifies all of the metadata associated with the selected products from those queries.

The query network system 140 may perform these tasks using a machine learning algorithm. The machine learning algorithm is able to correlate the query terms with the metadata from the presented results and the selections of the users 101 to detect trends and correlations in the data that can be used to predict the actual intent of users 101 based on the query terms.

In block 420, the query network system 140 uses metadata to infer the attributes they can be inferred from the shopping queries. The query network system 140 identifies metadata that is more commonly represented in the metadata of the products that are selected by the users 101. For example, if the most common metadata tag in the products selected by the users 101 is “superhero,” then the query network system 140 infers that in addition to a Spiderman costume, the user 101 might be interested in other superhero costumes, such as Superman. In an example, the query network system 140 ranks the metadata terms that are most commonly repeated in the selected products. The query network system 140 identifies as many of the metadata terms as being relevant as required based on a configured limit, based on a mathematical statistical analysis, or based on any other suitable standard. For example, if the top five metadata terms are represented with at least 50% of the selected products, then those five metadata terms are associated with that query.

Additionally, other attributes associated with the metadata maybe inferred by the query network system 140. For example, if the metadata indicated a super hero costume for a child under 10, the query network system 140 may recognize that these terms are more commonly associated with male children then with female children. The query network system 140 may thus add the term “male” to the list of metadata. Any other method to combine, sort, analyze, or parse the metadata terms may be employed by the query network system 140 to infer the user's intent.

The metadata attributes are often categorized for easier storage and retrieval. The categories may be selected by the query network system 140 to make retrieval of the attributes more efficient. The query network system 140 may use categories to group similar attributes to reduce the number of total attributes. For example, an attribute of “children” and “kids” may be combined into a single category to make the determined intent of the user 101 more broad. For example, the attributes may be stored in the following categories:

1. Feature tags: These describe the features, properties, or types of products. For example, for mattresses the feature tags might be “king size,” “queen size,” or “twin,” and for cameras there are tags such as “waterproof,” “42.4-megapixel” or “4 k video support.”

2. Age Groups: Some products might target specific age groups, such as “babies,” “toddler,” or “under 10.”

3. Categories: Products also belong to categories, such as “grocery,” “tools” “electronics,” or “clothing.”

4. Brands: product lines and merchants are also included as attributes in experiments.

In block 425, the query network system 140 stores inferred attributes for use in future shopping queries. For example, after selecting the top five metadata terms, the query network system 140 associates these terms with the query in stores the association on the web server 145. The next time a user 101 enters a query with the terms “Spiderman” and “costume,” the query network system 140 is able to access the web server 145 and identify the stored metadata terms.

From block 425, the method 305 returns to block 310 of FIG. 3.

In block 310, a graphical user interface presents a query object to a user 101 on a user interface 114 of a user computing device 110. In an example, a user 101 accesses a webpage 144 of the query network system 140, and a graphical user interface is presented to the user 101 on the user interface 114 user computing device 110. In another example, the graphical user interface is presented to the user 101 on an application operating on the user computing device 110 that is managed by, or operates in conjunction with, the query network system 140. Any other suitable graphical user interface that is presented by the query network system 140 or the user computing device 110 on the user interface 114 or in another suitable display may be utilized to present the search query operations to the user 101.

In block 315, a graphical user interface receives an unstructured query from the user 101. As shown in previous examples the unstructured query may be any word, phrase, sentence, question, or other query directed towards a group of products from which the user 101 might select a product for purchase. The user 101 may enter the query on an object presented on the graphical user interface presented on the user interface 114. For example, the user 101 might simply type in the terms of the query into a query box. In another example, the user 101 might state the query terms verbally into the user computing device 101 to begin the query. Any other suitable manner of submitting the query terms may be utilized.

In block 320, the graphical user interface inputs the terms in the query to the query network system 140. For example, the graphical user interface communicates the terms of the query to the query network system 140 via an Internet connection over the network 105, or by any other suitable communication method.

In block 325, the query network system 140 defines a set of implied attributes based on the query terms. In an example, the query network system 140 identifies other shopping queries with the exact terms of the current query and extracts the associated metadata terms. In another example, the query network system 140 identifies the metadata terms associated with each of the query terms or a subset of the query terms. A determination that the current query includes one or more terms related to a previous query is based on a comparison of each of the terms of the current query to each of the terms in the previous query to search for matches, wherein a greater number of matches indicates that the queries are more related. If all or most of the terms match, then the queries are determined to be related.

In another example, the query network system 140 identifies the metadata terms associated with one or more groupings of the query terms. For example, if the query included the search terms “Spiderman costume toddler,” the query network system 140 extracts the metadata terms associated with “Spiderman” and “costume” that were determined in the example of FIG. 4. The query network system 140 may also consider metadata terms associated with the search query term “toddler.” That is, the query network system 140 may infer the metadata terms identified earlier, such as “superhero,” “boy,” “under 10,” “Halloween,” “mask,” “Brand X Model 4321,” and “costume,” but also include metadata terms that are often associated with the term “toddler.” The metadata terms associated with “toddler” may be similar to some of the metadata terms associated with the inferred metadata term “under 10.” The query network system 140 may use the similarity of these metadata terms to refine even further the query search.

All of the metadata terms may be used by the query network system 140 to generate a structured, inferred query. For example, the terms may be assembled into a structured phrase or question that the query network system 140 could use to produce predictable, reasonable query results. The structured query may be configured in any suitable arrangement. In one such arrangement, the terms are structured into the following order: feature tags, age groups, categories, and brands.

In the example, after receiving the query “Spiderman costume toddler,” the query network system 140 may generate a structured query including some or all of the metadata terms, such as “Spiderman, Halloween, mask, male, under 10, toddler, costume, superhero, Brand X Model 4321.” This generated search query would provide results that are likely to be more closely directed to the intent of the user 101, while also including a smaller number of random results.

In block 330, the query network system 140 presents shopping options to a user 101 based on the structured query formed from the implied attributes. After generating the structured query, the query network system 140 performs a search based on the structured query and obtains results of products matching the query. The structured query is representative of the latent intent of the user 101. That is, the structured query is determined to be what the user 101 would have searched if the user 101 had entered a properly structured search based on the results that the user 101 actually desired with sufficient appropriate query terms to make the user's intent perfectly clear. The latent intent of the current query is based on the implied attributes determined from the stored metadata. Users 101 seldom optimize query terms to provide the query network system 140 with a clear intent of the user 101. Thus, the need exists to determine the latent intent behind the query terms that are actually submitted.

The query network system 140 presents the results to the user in the graphical user interface presented on the user interface 114. An example graphical user interface with example results is shown in more detail in FIG. 2.

FIG. 2 is an illustration of an example graphical user interface 120 displaying a query and query results, in accordance with certain examples. In the example, the graphical user interface 120 is displayed on a website 144 accessed by the communication application 112 on the user computing device 110 or in any other suitable manner and displayed on the user interface 114. The example graphical user interface 120 depicts a query search engine page with results from a query for “big high resolution tv” entered into the query entry box 202. The user 101 may enter the query in query entry box 202 via any suitable method, such as by typing the words on a keyboard on the user computing device 110. The query returned results for three product groupings. The example graphical user interface 120 illustrates attributes 204 used to refine the search. Attribute 204, for example, is the size of the TV. Attribute 204 illustrates that the query network system 140 determined that 65 or 54 inches are the likely sizes intended by the user 101 in the query of “big high resolution tv” entered into the query entry box 202.

Each returned product grouping is based on the structured inferred intent of the user 101 based on the input by the user 101 and the methods described herein. A structured inferred intent represents the query terms the user would have used to return the exact results that were selected in the search. For example, as shown in the display element 208, the top result is for TVs that are 65 inches, employ 4K UltraHD, are from the brand BigTVs, and are from merchants including Joe's TVs. These attributes were inferred from applying the methods herein to the query entry from the user 101. The two other display elements were populated by substituting second place attributes or alternative attributes, such as 54 inch TVs instead of 65 inch TVs in display element 106. An example query including the structured inferred intent may have been determined to be “65 inch, 4K Ultra HD, BigTV or FBNTV brand from Joe's TV or TV Depot.” This search query is more structured than the input query of “big high resolution tv.” If the user had entered a search query that was structured and sufficiently detailed, the method would not be needed to infer what the user actually intended.

Other display elements 206 and 209 display similar results based on the input by the user 101 and the methods described herein. For example, a 54″ Smart TV may be the second most likely inferred intent after a 65″ Smart TV. Display element 206 displays a search result with this inferred intent of 54″.

An example picture of a result of the query is shown as the TV picture 203. This picture 103 may be extracted from one of the shopping results in the display element 401.

In block 335, after the user 101 makes a selection of one or more products or links, the query network system 140 stores user selections and updates query network system 140 data. The update may be based on data collected when a user 101 simply clicks on a link provided in the results, when the user 101 actually makes a purchase, or when the user 101 provides any suitable feedback that the result was desirable or appropriate. Similarly, when a user 101 does not select an item, that information may be an indication that the result was not desirable or appropriate.

The query network system 140 may use this additional data to further train the BRRN 143 on the query network system 140. That is, every time a user 101 enters a query and makes a selection, the BRRN 143 uses that data to further train the BRRN 143 so that a more accurate interpretation of the latent intent of the user 101 may be made in subsequent shopping queries.

### Example Systems

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to render graphical user interfaces to display query results derived from latent query intent, comprising:
receiving, using one or more computing devices, result data for each item of a group of results, the result data comprising first metadata that is usable by the one or more computing devices and are not displayed with primary search results in a rendered graphical user interface on a user computing device;
receiving, using the one or more computing devices and from the user computing device, a first query comprising a data query, the first query being input into a graphical user interface hosted by the one or more computing devices;
identifying, using the one or more computing devices, one or more selections of results for the first query via an input on the graphical user interface on the user computing device;
associating, using the one or more computing devices, the first metadata associated with the selected results with the first query;
determining, using the one or more computing devices, that the first metadata is representative of latent intent of the first query;
receiving, using the one or more computing devices and from a second user computing device, a second query comprising a second data query, the second query being input into the graphical user interface hosted by the one or more computing devices;
determining, using the one or more computing devices, that the second query includes one or more terms related to the first query;
determining, using the one or more computing devices, a latent intent of the second query based on the associating of the first query and the metadata associated with the selected results, and based on the determination that the second query includes one or more terms related to the first query; and
providing, using the one or more computing devices, instructions to the user computing device causing the user computing device to render a graphical user interface comprising second query results, based on the determined latent intent of the second query.

2. The computer-implemented method of claim 1, further comprising presenting, by the graphical user interface on the user computing device, the query results.

3. The computer-implemented method of claim 1, wherein the metadata is received as product tags associated with a product description.

4. The computer-implemented method of claim 1, wherein the determination that the second query includes one or more terms related to the first query is based on a comparison of each of the terms of the second query to each of the terms in the first query to search for matches, wherein a greater number of matches indicates that second query and the first query are more related.

5. The computer-implemented method of claim 1, wherein the one or more computing devices comprise a machine learning computing system as a part of the query network system configured to receive inputs of product data and the metadata associated with the products, the metadata in particular being associated tags or other data transmitted by a system with the product data, the query system storing the product data that are actually selected by users based on queries, in particular shopping queries to learn the latent intent of the users when submitting the query.

6. The computer-implemented method of claim 1, wherein the one or more computing devices employs a neural network to perform each of the determinations.

7. The computer-implemented method of claim 6, wherein the neural network is a bidirectional recurrent neural network.

8. The computer-implemented method of claim 1, wherein the one or more computing devices employs a machine learning algorithm to perform each of the determinations.

9. The computer-implemented method of claim 1, wherein the determined latent intent of the first query comprises a set of structured search query terms that were intended in the search query based on the metadata associated with the selected results.

10. The computer-implemented method of claim 1, wherein the one or more selections of results include receiving a selection of a link presented in the results displayed via the graphical user interface on the user computing device.

11. The computer-implemented method of claim 1, wherein determining that the second query includes one or more terms related to the first query is based on a comparison of the first query terms to the second query terms.

12. The computer-implemented method of claim 1, wherein the determined latent intent of the second query comprises a set of structured search query terms that were intended in the search query.

13. The computer-implemented method of claim 1, wherein the latent intent of the second query comprises a set of structured search query terms that were intended in the search query based on the determined latent intent of the first query.

14. The computer-implemented method of claim 1, wherein attributes of the latent intent of users is categorized into one or more categories.

15. The computer-implemented method of claim 14, wherein the one or more categories includes one or more of a brand name, a product feature, and an age group of a likely purchaser.
